(19) United States
(12) Patent Application Publication
(10) Pub. No.: US 2005/0045555 A1
(43) Pub. Date: Mar. 3, 2005

(54) Grease and oil separator ladle

(76) Inventor: Charles Taylor, San Jose, CA (US)

Correspondence Address: Charles Taylor, 1814 Monument Dr., Lincoln ( Sun City), CA, 95648, US

(21) Appl. No.: 10/646,180

(22) Filed: Aug. 25, 2003

(51) Int. Cl. C02F 1/40

(52) U.S. Cl. 210/514; 99/496; 99/508

(57) ABSTRACT

The Grease and Oil Separator Ladle is a special deep-bowled long-handled grease and oil separator kitchen tool. The purpose of this kind of ladle is to remove of the excess fat or cooking oil from the top of soup, or other kind of liquid, by having a built in perforated dome in the middle of its concave part. The dome collects the fat or cooking oil and releases into the collection part of ladle thorough the holes located on the dome. It should be used only for warm liquid having grease or oil swimming on the top, like warm soup.

### FIELD OF INVENTION

It has been designed for household and restaurant use, but it is not limited for them only. The possibility for some industrial application can be real too. But this invention relates mostly to cooking, producing soups and other greasy or oily foods where the extra fat is undesirable and not healthy.

### BACKGROUND OF THE INVENTION

The application is related to cooking and other activities where the removal of liquid fat or liquid oil has to be accomplished. Removal of excess fat or oil from the soup or stew would help to create healthier food for children and adults.

Lots of oil decanter/separator device is used in the industry that are used mostly in the chemical and food industry but none of them would be applicable in the household or restaurant business. Most of them are based on the help of some kind of mechanical device to separate the fat/oil from the water. These two patents: Oil removal device (U.S. Pat. No. 5,427,681) and Oil recovery system (U.S. Pat. No. 5,380,431) are such kind. Most of the Ladle related patents are design and not utility patents.

### SUMMARY OF THE INVENTION

This invention seeks to realize a hand held device, a so-called separator ladle that not only help to remove liquid fat or oil from the top of warm soup/liquid but also contributes to create a more healthy food. The right size and the practical design of the handle make it easy to use. The long plastic handle insulates the user's hand from the heat of the treated liquid when used to remove the excess fat or oil from the warm food.

### BRIEF DESCRIPTION OF DRAWINGS

The attached drawings serve to provide understanding of the proposed invention:

FIG. 1. is the Top View of the device, indicating the raised middle part with holes in it. Also the form of the ladle and the handle can be seen.

FIG. 2. is the Front View where the guiding slots outside the bowl can be seen.

FIG. 3. is the Side View where also the liquid guiding slots and the flat part of the ladle is visible where the raised hollow portion starts and the slots end..

FIG. 4. is a Cross Section View where the hollow protrusion with the holes are visible.

FIG. 5. is the Bottom View where the liquid guiding slots and middle part as a hole is visible.

FIG. 6. is a Cross Section View showing the collection of the liquid fat/grease or oil in a cooking pot.

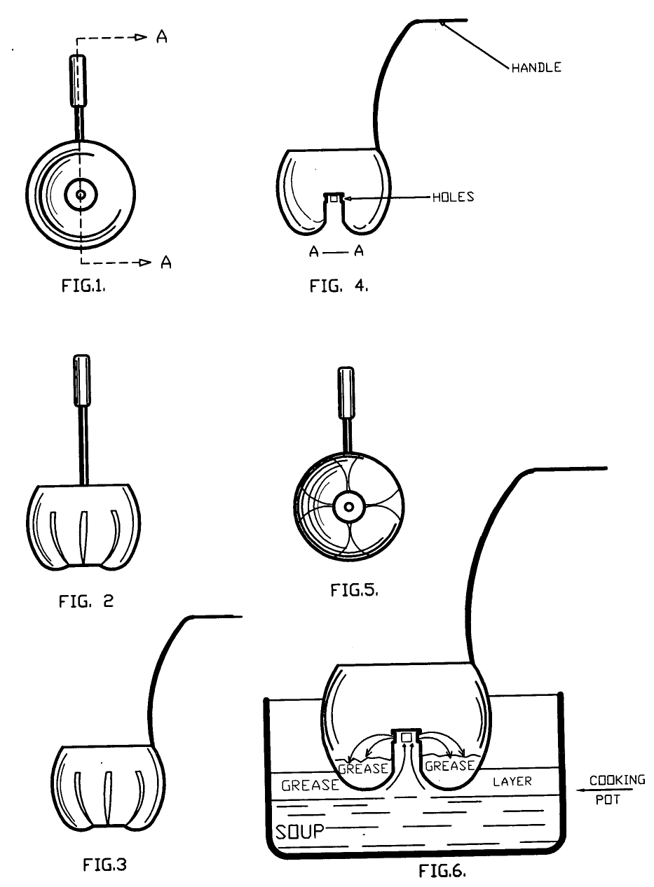

### DETAILED DESCRIPTION

The preferred embodiment comprises a deep, bow-like ladle containing a raised section in the middle, having appropriate size of holes on it and a long vertical handle, which is curved at the end. Material of the device can be plastic or metal, but most likely the preferred material would be food-safe plastic.

When the Grease and Oil Separator Ladle put on the top of the fatty liquid and gently push down the liquid fat/grease or oil will start flowing through the holes. The fatty liquid material will be collected in the bowl under the raised section. After the collected material reaches the level of the holes in the bowl, it shall be poured out and the ladle used again until the desired quantity of liquid fat or oil of the soup is removed.

1. A kitchen tool which capable of collecting warm, liquid grease or oil from the top of soup or other liquid.

2. A special ladle having a hollow protrusion, with holes on it, inside the bowl to collect the liquid grease or oil in the available space around the protrusion in the bowl.

3. The above mentioned kitchen tool that is capable of collecting warm grease or cooking oil from the top of a warm liquid by inserting and pushing it down partially under the surface of the liquid until the the warm grease or oil starts to flow trough the holes.
